(19) United States
(12) Patent Application Publication
(10) Pub. No.: US 2006/0072441 A1
(43) Pub. Date: Apr. 6, 2006

(54) Record carrier comprising multiple sets of recording parameters

(75) Inventors: Johannes Hendrikus Maria Spruit, Eindhoven (NL); Johannes Cornelis Norbertus Rijpers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,630

(22) PCT Filed: Nov. 18, 2003
(86) PCT No.: PCT/IB03/05276

§ 371 Date: Jun. 10, 2005

(30) Foreign Application Priority Data
Dec. 13, 2002 (EP) 02080327.6

(51) Int. Cl. G11B 7/24

(52) U.S. Cl. 369/275.1

(57) ABSTRACT

The invention relates to a record carrier which comprises multiple sets of recording parameters for a recording process. The recording parameters define a so-called write strategy for converting an information signal to be recorded into a pulsed radiation beam for recording the information on the record carrier. By providing multiple sets of recording parameters, each set related to a specific range of recording speeds, good quality recordings are obtained at various recording speeds.

The invention relates to an optical record carrier capable for recording information thereon by irradiating the record carrier by a pulsed radiation beam, said record carrier comprising an area containing control information indicative of a recording process by which the information can be recorded on said record carrier, the control information comprising values of recording parameters for the recording process.

Disc shaped optical record carriers according to the preamble are well known and include, but are not limited to, CD-Recordable (CD-R), CD-Rewritable (CD-RW), DVD-Recordable (DVD-R, DVD+R) and DVD-Rewritable (DVD-RAM, DVD-RW, DVD+RW) disc. Information is recorded on such record carriers by irradiating the record carrier by a pulsed radiation beam while the record carrier is rotated at a certain recording speed relative to the position of the radiation beam. The sequence of pulses of the pulsed radiation beam, that is, the pattern of pulses and gaps between the pulses, is representative for the information to be recorded. The information to be recorded is converted into the pulsed radiation beam by a recording device. The relation between the information to be recorded and the corresponding pulsed radiation beam is defined by a so-called write strategy. These write strategies are, in general, specified in the system specification for a specific optical recording system, such as for example the DVD+ReWritable System Description; Basic Format Specification.

However, it appeared that a write strategy could not be fully specified independent of the record carrier to be recorded itself. To obtain good recording results, certain properties of the write strategy need to be adapted for each individual record carrier. Such properties include, for example, the duration of the pulses in the pulsed radiation beam, the duration of gaps in between the pulses, and the ratio between a write power level and an erase power level. These properties of the write strategy are defined by the recording parameters.

To ensure that appropriate values for the recording parameters are used during recording of a specific record carrier, the values for the recording parameters are stored on the record carrier itself. Before the actual writing of information to the information layer of a record carrier, a recording device reads the values for the recording parameters from the record carrier itself, and will subsequently use these read values when converting the information into the pulsed radiation beam.

Using the values for the write parameters stored on the record carrier itself will insure proper recording of information on the record carrier in a specified range of recording speeds. In general the values for the write parameters stored on the record carrier are such that they allow the record carrier to be recorded in Constant Angular Velocity (CAV) mode in which the angular recording speed remains constant while the linear recording speed increases from the inner radius (ID) to the outer radius (OD) of a disc shaped record carrier. For a standard size CD or DVD disc, having a diameter of 12 cm, the linear recording speed varies by a factor of 2.4. For example, the DVD+ReWritable System Description; Basic Format Specification specifies that the values for the write parameters stored on the disc should be such that good recording of information is obtained when recording in CAV mode at a linear recording speed in a range from 3.49 m/s (referred to as 1× for DVD-systems) to 8.44 m/s (referred to as 2.4× for DVD-systems).

Currently, record carriers are being designed for recording at higher recording speeds. These record carriers physically allow recording at a recording speed higher than that specified in the current system specification. However, when these record carrier are recorded at these higher recording speed using the values for the write parameters stored on the record carrier, bad quality recordings are obtained. The quality of a recording is, for example, quantified by the jitter of the recorded marks representing the recorded information. This jitter is the standard deviation of the time difference between level transitions in a digitized read signal obtained from reading the recorded marks and the corresponding transitions in a clock signal, the time differences being normalized by the duration of one period of said clock signal.

It is an object of the present invention to provide a record carrier and a method which allow good quality recording of information using higher recording speeds. This object is achieved by providing a record carrier according to the preamble which is characterized in that the control information comprises a first set of recording parameters for the recording process at a first range of recording speeds, and a second set of recording parameters for the recording process at a second range of recording speeds.

Such a record carrier according to the inventions allows a recording device to selectively read the values for the recording parameters from the record carrier itself depending on the recording speed used to write information on the record carrier. The record carrier may, for example, comprise a first set of recording parameters for the recording process at a first range of recording speeds from 3.49 m/s (referred to as 1× for DVD-systems) to 8.44 m/s (to as 2.4× recording for DVD-systems), and a second set of recording parameters for the recording process at a second range of recording speeds from 5.77 m/s (referred to as 1.6× for DVD-systems) to 13.95 m/s (referred to as 4× for DVD-systems). Now, a recording device capable of recording at the higher (that is, the second) range of recording speeds will, in an initialization step, read the second set of write parameters from the record carrier and will subsequently, in a writing step, use this second set when converting the information into the pulsed radiation beam, while a recording device only capable of recording at the lower (that is, the first) range of recording speeds will read, in the initialization step, the first set of write parameters from the record carrier and will subsequently, in the writing step, use this first set when converting the information into the pulsed radiation beam. In this way, both when recording at the lower recording speed and when recording at the higher recording speed, good quality recordings are obtained. Moreover, it allows the record carrier to be used both in recording devices capable of recording at the higher recording speed only and in recording devices capable of recording at the lower recording speed only. In this way, so-called backwards compatibility of the record carrier is achieved.

It is noted that, although the before-mentioned example explains the invention based on two sets of recording parameters, any number of sets may be stored on the record carrier. Each of the sets comprises the recording parameters for the recording process at a specific range of recording speeds. In this way a multitude of ranges of recording speeds may be supported.

In an embodiment of the record carrier according to the invention the first range of recording speeds partially overlaps the second range of recording speeds. This allows for an enlarged range of recording speed to be used, which is especially advantages when recording in CAV mode. In the before-mentioned example of the record carrier the range of linear recording speeds is extended from a factor of 2.4 (1×-2.4×) to a factor of 4 (1×-4×).

In an embodiment of the record carrier according to the invention a recording parameter is indicative of a write strategy, said recording parameter having a first value in the first set of recording parameters indicative of a first write strategy and having a second value in the second set of recording parameters indicative of a second write strategy. In this way not only the recording parameters are adapted to a specific range of recording speeds, but also alternative write strategies may be used for different ranges of recording speeds, thus increasing the flexibility of a recording device to optimize its recording process.

These and further aspects and advantages of the invention will be discussed hereinafter with reference to the appended figures, where

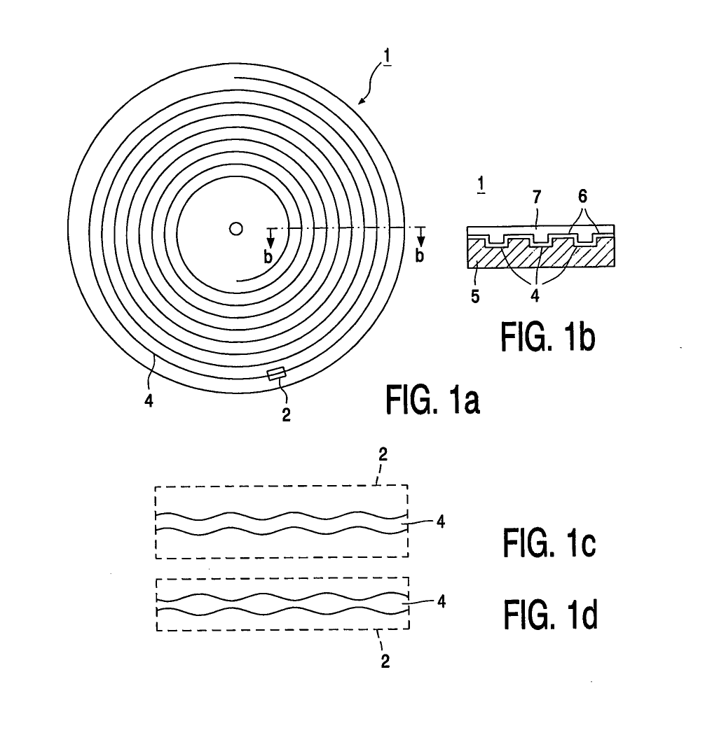

FIG. 1 shows a record carrier according to the invention,

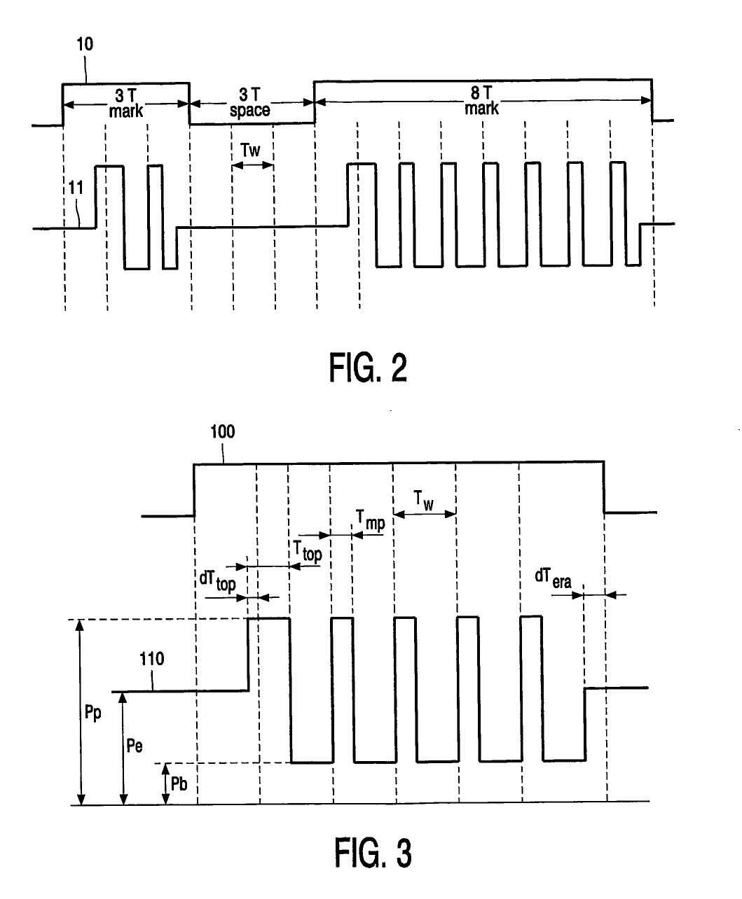

FIG. 2 shows a digital information signal and the related control signal for controlling the radiation beam, and

FIG. 3 shows a digital information signal and the related control signal adjusted in accordance with a set of recording parameters.

FIG. 1 shows a possible embodiments of a record carrier 1 of an inscribable type. FIG. 1a is a plan view. FIG. 1b shows a small part of a sectional view taken on the line b-b. FIGS. 1c and 1d are highly enlarged plan views of a part 2 of a first embodiment and a second embodiment of the record carrier 1. The record carrier 1 has a track 4, constituted for example by a preformed groove or ridge. The track 4 is intended for recording an information signal. For the purpose of recording the record carrier 1 has been provided with a recording layer 6 deposited on a transparent substrate 5 and coated with a protective layer 7. The recording layer 6 is of a material which, when exposed to suitable radiation of adequate intensity, is subjected to an optically detectable change. Such a layer may be, for example, a thin layer of a metal such as tellurium. By exposure to laser radiation of suitable intensity this metal layer can be melted locally, so that at this location said layer will have a different reflection coefficient. When the track 4 is scanned by a radiation beam whose intensity is modulated in conformity with the information to be recorded an information pattern of optically detectable recording marks is obtained, which pattern is representative of the information. The layer may alternatively consist of other radiation sensitive materials, for example a dye, or materials which upon heating are subjected to a structural change, for example from amorphous to crystalline or vice versa.

The track 4 enables a radiation beam which is aimed at the record carrier 1 for the purpose of recording the information to be positioned accurately on the track 4, in other words it enables the position of the radiation beam in a radial direction to be controlled via a tracking system employing the radiation reflected from the record carrier 1.

The control information indicative of a recording process is recorded in the track 4 by means of a preformed track modulation, suitably in the form of a sinusoidal track excursion as shown in FIG. 1c. However, other track modulations such as for example track width modulation (FIG. 1d) are also suitable. Since a track excursion is very easy to realize in the manufacture of the record carrier it is preferred to use a track modulation in the form of such a track excursion. It is to be noted that FIG. 1 shows the track modulation to a highly exaggerated scale, and it also shows the track pitch (the spacing between the track centers) to a substantially larger scale than in reality.

An attractive track modulation is that in which the frequency of the track modulation is modulated in conformity with the values of the control information indicative of a recording process. However, other track modulations are also possible.

An improved method of storing the control information indicative of a recording process on a record carrier is described in the International Application WO 02/49019. This method is especially advantages when a large amount of control information needs to be stored on the record carrier, such as in the case of a large number of sets comprising the recording parameters.

In optical systems, such as for example a DVD+RW system, the control information indicative of a recording process which is stored in such a modulated track is often referred to as Address-in-Pregroove or ADIP. This control information stored in the ADIP comprises the values of the recording parameters for the recording process, often referred to as write strategy parameters. Besides the recording parameters, the ADIP may also comprise, for example, information regarding the disc manufacturer, the disc media type, and the disc product revision number.

FIG. 2 shows a digital information signal 10 representing the information to be recorded on the record carrier 1. The value of this digital information signal 10 represent the lengths of marks to be recorded in the recording layer 6 of the record carrier 1. The vertical dashed lines indicate transitions in a reference clock signal belonging to the digital information signal. One period of this reference clock, also called the channel bit period, is indicated by Tw.

The digital information signal to be recorded is converted into a control signal 11 which controls the power of the pulsed radiation beam, where it is assumed that the power of the pulsed radiation beam is proportional to the corresponding level of the control signal 11. The relation between the information to be recorded and the corresponding pulsed radiation beam is defined by a so-called write strategy. In the embodiment shown in FIG. 1, a so-called (N-1) write strategy is applied. By sucg a (N-1) write strategy, a mark in the digital information signal 10 having a length of nT (that is, a time length of n times Tw) is converted into a series of n-1 pulses in the control signal 11. For example, a 8T marks is converted into a sequence of 7 pulses and a 3T mark is converted into a sequence of 2 pulses.

FIG. 3 shows a digital information signal 100 representing a 6T mark to be recorded on the record carrier 1. The digital information signal 100 to be recorded is converted into a control signal 110 by a (N-1) write strategy resulting in a sequence of 5 pulses. These pulses are modulated between a write power level Pp and a bias power level Pb. The power level before and after the sequence of pulses is at an erase power level Pe, which corresponds to an erase power level of the radiation beam capable of erasing previously written marks between the marks being written. The actual shape of the sequence of pulses (that is, the wave shape) depends on a number of recording parameters dTₜₒₚ, Tₜₒₚ, Tₘₚ, and dTₑᵣₐ, where Tₜₒₚ defines the duration of the first pulse in a sequence, Tₘₚ defines the duration of the pulses except for the first pulse in a sequence, dTₜₒₚ defines the start of the first pulse relative to a transition of the reference clock signal, and dTₑᵣₐ defines the end of the sequence of pulses relative to a transition of the reference clock signal. These recording parameters are read from the record carrier itself before the actual recording of information.

On the record carrier according to the invention, the control information, stored for example in the ADIP, comprises at least two sets of recording parameters for the recording process. Each set intended to be used by a recording device when recording information at the corresponding range of recording speeds. To identify a specific set, its corresponding range of recording speeds could, for example, be included in the set itself as one of the recording parameters. Alternatively, the control information could comprise pointers to the location of the sets in the ADIP, which pointers are linked to the ranges of recording speeds.

As an example, a DVD+RW disc according to the invention produced by the applicant comprises two sets of recording parameters; a first set for recording information at a linear recording speed in the range from 1× to 2.4× in which dTₜₒₚ equals 0.33T, Tₜₒₚ equals ⅙T+2.0 ns, Tₘₚ equals 2/6T+2.0 ns, and Pe/Pw equals 0.5, and a second set for recording information at a linear recording speed in the range from 1.6× to 4× in which dTₜₒₚ equals 4/16T, Tₜₒₚ equals 1/16T+6.0 ns, Tₘₚ equals 2/16T+4.2 ns, and Pe/Pw equals 0.3.

1. An optical record carrier capable for recording information thereon by irradiating the record carrier by a pulsed radiation beam, said record carrier comprising an area containing control information indicative of a recording process by which the information can be recorded on said record carrier, the control information comprising values of recording parameters for the recording process,
characterized in that
the control information comprises a first set of recording parameters for the recording process at a first range of recording speeds, and a second set of recording parameters for the recording process at a second range of recording speeds.

2. A record carrier according to claim 1, wherein the first range of recording speeds partially overlaps the second range of recording speeds.

3. A record carrier according to claim 1, wherein at least part of the recording parameters define the sequence of pulses of the pulsed radiation beam.

4. A record carrier according to claim 1, wherein a recording parameter is indicative of a write strategy, and wherein said recording parameters has a first value in the first set of recording parameters indicative of a first write strategy and a second value in the second set of recording parameters indicative of a second write strategy.

5. A method of recording information in an information layer of a record carrier by irradiating the information layer by a pulsed radiation beam,
the method comprising
an initialization step of reading values of recording parameters for a recording process by which the information can be recorded on the record carrier from an area on the record carrier containing control information indicative of the recording process, and
a writing step in which the information to be recorded is converted into a pulsed radiation beam, said conversion based on the read values of the recording parameters,
characterized in that
in the initialization step a first set of recording parameters is read when the information is to be written at a first range of recording speeds, and a second set of recording parameters is read when the information is to be written at a second range of recording speeds.

6. A recording device for recording information in an information layer of a record carrier by irradiating the information layer by a pulsed radiation beam, capable of carrying out the method according to claim 5.
